(19) United States
(12) Patent Application Publication
(10) Pub. No.: US 2025/0312688 A1
(43) Pub. Date: Oct. 9, 2025

(54) SYSTEMS AND METHODS FOR DISPLAYING CONTENT TO A USER

(71) Applicant: FrontRow Sports LLC, Burlington, MA (US)

(72) Inventors: George Simiakakis, Athens (GR); Rand Anderson, Manchester, NH (US)

(73) Assignee: FrontRow Sports LLC, Burlington, MA (US)

(21) Appl. No.: 19/171,762

(22) Filed: Apr. 7, 2025

Related U.S. Application Data
(60) Provisional application No. 63/575,239, filed on Apr. 5, 2024.

(51) Int. Cl. A63F 9/18; A63F 13/798

(52) U.S. Cl. CPC A63F 9/18; A63F 13/798; A63F 2009/188

(57) ABSTRACT

Computer-implemented methods of generating an AI-enhanced trivia game by leveraging AI generated content already generated by a system. The system comprising a server storing media, statistics and AI generated content for a prediction game, a repurposing memory cache storing used AI generated content from the prediction game as potential question prompts for a trivia game, and a minigame processor configured to select subsets of question prompts from the repurposing memory cache and operate the in-app trivia minigame. The repurposed AI generated content maintains the AI elements generated using computationally expensive techniques such as machine learning. The minigame processor analyzes the AI generated content in the repurposing memory cache to select the subsets, allowing a traditional computer processor to use low cost methods to generate a trivia minigame which leverages the value provided by the AI generated content without reemploying computationally expensive AI processes.

### CROSS REFERENCE TO RELATED APPLICATIONS

This application claims the benefit of priority under 35 U.S.C § 119(e) of U.S. Patent Application Ser. No. 63/575,239, filed Apr. 5, 2024, which is hereby incorporated by reference in its entirety.

### BACKGROUND

Online gaming has grown substantially over the last decade and it continues to grow. Online games are enjoyable and provide a way for people to socialize and participate in recreational activities that build bonds and friendships. The demand for online games continues to grow and game developers are faced with challenges of how to develop games that will entertain people and how to develop these games quickly enough to satisfy relentless consumer demand for entertaining games. Today, game developers feel significant pressure to develop and release new games to keep users involved and interested.

But the growth of online gaming has also driven the growth of online server farms that host hundreds of thousands of computer servers processing the operation of the games. Online games can be computationally demanding. The resources employed to generate content, including image content for the gamer, can be and often is substantial. The computational resources required, including electrical power, can also be substantial. See Mills, E., Bourassa, N., Rainer, L. et al.; Toward Greener Gaming: Estimating National Energy Use and Energy Efficiency Potential.; Computer Game J 8, 157-178 (2019). In particular, the use of AI systems to generate content for online games requires significant computational resources, for example it is a known problem in the field of AI that LLM models such as ChatGPT require significantly more power than a traditional search engine to answer a user's query. A similar power and resource expense can occur between AI generated gaming content and traditional content generation methods. Further, cloud-gaming energy use in datacenters and networks is markedly higher than that for local gaming. In all cases, the impact on resources of on-line gaming is often overlooked by the general public. But online gaming accounts for about 2.4% of consumed residential electricity nationally, which is notably more that the total amount of residential electricity consumed by the average state in United States.

Therefore, there is a need for improved systems for allowing developers to develop new games and do so in a manner that responsibly uses their time and other resources

### SUMMARY

The systems and methods described herein include, in one embodiment, a system which comprises a server storing media and statistics from previously played contests in a sports league and AI generated question prompts for a first game. Media can include images of players during gameplay, headshots of players, team logos, images of stadiums, and names of players and teams. The AI generated question prompts are generated by an AI system analyzing large quantities of sports data and determining a statistical threshold about a particular player, team or matchup between players and teams which the AI system determines has about a 50% chance of occurring. The AI system then combines the AI generated statistical threshold, the stored media, and the stored statistics to create the AI generated question prompts which are then stored on the server. The AI generated question prompts are used in the first game by each prompt presented to a user asks the user to predict whether or not the AI generated statistical threshold will be met in the upcoming contest. The system further comprises a repurposing memory cache which stores the AI generated question prompts and the accompanying metadata corresponding to each prompt. A minigame processor is configured to access the repurposing memory cache, analyze the stored AI generated question prompts, and select a subset of the stored question prompts to generate a set of trivia question prompts where each trivia question prompts corresponds to a stored AI generated question prompt from the first game. The minigame processor then uses the subset of trivia question prompts to operate a second game with the repurposed AI generated content intended for the first game.

In some embodiments, the AI system produces, for each AI generated question prompt, and AI generated storyline element. The AI generated storyline can be represented as a short phrase which provides a user with context about the question prompt. The AI system generates the AI generated storylines by analyzing large quantities of data to identify statistical trends or other statistically significant scenarios which may be interesting to a user. The AI generated storylines may include a predetermined set of categories, which the AI system then organizes the identified statistical trends, where each category in the set of categories corresponds to a short phrase which will be presented to the user as the Storyline element within the AI generated question prompt.

In some embodiments, the trivia question prompts correspond to the AI generated question prompts comprises the trivia question prompts utilizing the AI generated statistical threshold, AI generated storylines, stored media and stored statistics which were used in the AI generated question prompt for the first game.

Alternatively, the AI generates statistical thresholds may comprise a comparison between two teams or two individual players performance in a particular statistic where the AI system has determined the probability of one team or player performing better in the particular statistic to be about 50%.

In some embodiments, the minigame processor operating the minigame comprises presenting the user with the subset of trivia questions as a series of yes or no questions regarding whether or not the AI generated statistical threshold was met during the previously played contest in question. The user is given a time limit to answer each question and receives more points for correctly answering the question faster. The completion of each question in the subset, or the time limit of each question expiring, comprises a round of the minigame. Upon completion of a round of the minigame, the user is presented with a recap section which displays statistics regarding the users' performance in the round, such as the score and average answer speed. Optionally, the recap section may include statistics regarding a different user's performance in the same round of the minigame for comparison by the first user.

The minigame processor may select trivia question prompts for the subset using different criteria to establish a theme to the subset and/or ensure a desired level of variety within the subset. For example, the minigame processor may select trivia questions which all have the same AI generated storyline, to present a user with a round of the minigame with a theme which corresponds to the storyline. Furthermore, the processor may, for themed or non-themed subsets, that any one player is included in a maximum of 2 selected questions, to ensure a variety of players are in the subset. Other types of themes or variety criteria may be used by the minigame processor when generating subsets of trivia questions for the minigame.

### BRIEF DESCRIPTION OF DRAWINGS

FIG. 1 depicts a flow diagram of the system from server to mobile computing device.

FIG. 2 depicts a process for generating game content.

FIG. 3 depicts an example of prediction game content.

FIG. 4 depicts repurposed prediction game content for a trivia minigame.

FIG. 5 depicts a block diagram of the user experience of the trivia minigame.

FIG. 6 depicts an example of a trivia minigame being presented to a user

FIG. 7 depicts an example of a trivia minigame lobby screen

FIG. 8 depicts an example of a trivia minigame starting instructions screen

FIG. 9 depicts an example of a proposed trivia question in a trivia minigame.

FIG. 10 depicts an example of an answered trivia question in a trivia minigame.

FIG. 11 depicts an example of a recap screen of a trivia minigame.

FIG. 12 depicts an example of an answered trivia question in a trivia minigame.

FIG. 13 depicts an embodiment of the system which repurposes content for a prediction game as content for a trivia minigame.

### DETAILED DESCRIPTION

The systems and methods described herein teach a system wherein AI generated content used in a first game is then stored in a cache memory and repurposed from into a format suitable for a subsequent trivia game. The AI generated content is computationally expensive to produce, and with the systems and methods described herein can be repurposed for use with a different system other than the one it was designed for without expensive modification to the content itself.

In one embodiment, the system comprises a server for storing a combination of statistical and media data and AI generated content which is converted into an AI generated question prompt for a prediction game. The AI generated question prompts are used in a prediction game where a user predicts if the player of team will meet an AI generated statistical threshold and are provided with contextual data and an AI generated storyline providing further context for the question prompt. The AI generated content is accessed by a repurposing memory cache which stores the prediction game question prompts after the contest as issue has completed. The prediction game question prompts are reformatted as trivia game questions and an in-app minigame processor analyzes the content of the repurposing memory cache to select a subset of questions following various themes. In a typical embodiment, the in-app processor will select a set of 10 trivia questions from the memory cache which all have the same AI generated storyline while maintaining certain parameters within the subset such as a level of variety of players and teams within the subset. The in-app minigame processor then sends each selected subset to the in-app minigame where each themed subset can be presented to a user as a round of the trivia minigame. Using these systems and methods, a trivia game can be operated which leverages the value provided by complex and computationally intensive and costly analysis of large data sets performed by AI systems with only a traditional computer processor and the lower power requirements therein.

In the field of online gaming, the server costs related to the storing of data has become a core aspect of the business. Web hosting services, such as AWS, along with more specific data services, such as SportRadar in the U.K., allow online gaming businesses to access the data they need to generate game content without having to host their own servers or data repositories. These services are vital to online gaming, but represent a significant cost to the businesses and as the online gaming sector grows, there is increasing strain on these services. There is a need for more efficient means of production of online gaming content, in particular ensuring that the content which is most computationally expensive is used as an asset and mined for as much value as possible, minimizing the amount of single-use content requiring computational resources for generation, and server cost for storage. The systems and methods described herein teach a system which repurposes AI generated content for use in an additional online minigame without the need to reincur the cost of generating the content. This method allows for the operation of an AI-enhanced minigame which does not need to directly employ AI content generation of data analytics, while maintaining the advantages AI systems provide in generating compelling questions and identifying meaningful insights from large quantities of data.

In one embodiment, the systems described herein for operating the prediction game determine that there is a newsworthy, or comment worthy event related to topic of shared interest to a large community of users. In one example relevant to apps that focus on the domain of high school Sports, an event is Newsworthy and worth posting in a Storyline, if a discussion about the event is (i) timely (current, about upcoming games, such as the user's upcoming High School Thanksgiving day football game), (ii) significant (the performance of teams and players that are the subject of the stories that the app publishes are important to people that follow the sport), (iii) has proximity (users, typically while setting up a user profile, will note their favorite sports, teams, etc., so the Storylines that the app publishes for a user's personalized feed, are prioritized based on the subjects that are “proximate” to that user as specified in the user profile, (iv) prominence (stories are about well-known leagues, teams and players), and (v) human interest (people care about the subjects of their stories—many fans feel they have a relationship with their favorite teams and player—this para-social relationship feels as real as their relationships with friends and acquaintances). For example, in the domain of major league sports, the system may determine that a particular NBA basketball player is on a scoring streak of scoring more than 25 points per game. The system may also determine that this pace is statistically exceptional, especially for this player, being, for example, two or three standard deviations above relevant means. The system may process this statistical data into a succinct question, such as will player X's streak of scoring more than 25 points per game continue in tonight's game? In another example related to finance, the system may determine that the stock price of a certain company is a standard deviation above relevant means for price to earnings ratios, and formulate the question whether the price will regress to the mean over the next two weeks. In either example, the noteworthy pattern becomes the basis for generation a new posting on the app, while historical data about the topic is used to generate an argument-worthy premise that is included in the posting. Other relevant information is included in the posting and may be published based on a priority determined by the user preferences. These prioritization and filtering mechanisms achieve the objective that the Storylines the user choses to react to are personally interesting. However, generating the Storylines requires significant computational resources and analysis over often very large quantities of data. There is a need for systems which can leverage this expensive content to provide value in multiple ways to improve the overall efficiency of online gaming systems by utilizing expensively produced content multiple times. In the exemplary embodiment, the user as well as others that view the media messages (i.e. content) generated by the user's reaction to the Storyline are unlikely to perceive that content as authentic and personal without a high affinity to the topic and the protagonists.

Preferably, the Storyline posting is formatted to facilitate quick reaction from users, and any reactions become part of the post, increasing its priority for users that are connected through personal social graphs maintained by the application. The application also allows one user to transmit selected postings to another user directly through an integrated in-application chat/Direct Messaging channel. Optionally, the posting may be formatted to allow the receiving user to react to the posting with the same simple swipe gesture or other user-selectable switch, used in the primary posting channel (feed). Those reactions are similarly shared with others who the user is connected with through his or her social graph, and used by the system in follow-on content generation when scanning for notable patterns in these reactions.

To this end, certain embodiments of the systems and methods described herein will include systems and methods that scan large amounts of data about a certain topic, looking for noteworthy patterns of performance by a range of protagonists, and then matches pools of notable performances with information about upcoming events that involve any relevant protagonists from the pool. Unlike traditional manually-intensive publishing methods, the application need not be influenced by the popularity of a protagonist, or limited by the number of reporters or writers on staff. The systems described herein may consider and analyze the performances for the full universe of protagonists currently active in a topic. Data analysis on this scale is useful for generating unique and engaging content, but requires significant computational resources, as such there is a need for systems which identify valuable but expensive content, and utilize this valuable material more fully before it is discarded. For example, when publishing stories about a professional sports league, the system can consider all teams and all players equally, and uncover patterns that would be practically impossible to detect using traditional research and publishing methods. Additionally, postings published are formatted to include a premise that defines opposing sides for performance by a protagonist in an upcoming event, and to make it easy for users to react and take a side based on their personal points of view. A large and diverse volume of postings by the application increases the likelihood that each user in a small circle of friends will be react to a posting that the others in that circle have not seen yet. Moreover, the system automatically propagates the sided reaction by one first user to other users that the first user is connected with via a social graph that the system generates based on user preferences and based on existing relationships among protagonists within a given topic. The social graph can represent a network of relationships, wherein a relationship is representative of an association between the first user and a second user of the system and wherein the association is determined based on monitoring the choices selected by the user.

Certain embodiments of the systems and methods described herein will include systems and methods that allow the application to also serve as a personalized story tracker to help manage a high volume of Storylines and Takes. For example, for a given sports league in season, the application can keep track of every Take by date and by game, so the user can easily navigate and stay on top of hundreds of active Storylines at the same time and in real-time. The systems and methods described herein improve publishing volume and speed about a topic, as well as increase the ease of content production by each user, thereby increasing the percentage of users that publish on an app, and provide a user with a tool for participating in on-going discussions as a contributor of original personal content, thus further increasing engagement within a community.

In one particular embodiment, the systems and methods described herein include a domain specific social media application, such as a social media application that curates sports content and exchanges of reactions and commentary about sports content among members of the on-line community. In one example, a social media application that curates sports content allows users to express easily a clear point of view on a topic. For example, a social media application of the type described herein will post stories that embed premises that may prompt users, or some users, of the application, for a prediction about an upcoming game, presenting the prompt in a format that users can either agree-with or disagree-with. A user can make a simple motion, such as a screen swipe, to indicate whether the user agrees or disagrees. The systems and methods described herein respond to the user reaction to the prompt and apply a template to enhance the post with the users Take on that game, so that it can be published on the social media application as user-generated content. Additionally, the system automatically creates personal highlights and dynamic stories in each user social media profile by analyzing the reactions of each user looking for notable patterns. Social media apps usually include a Profile section that stores and provides to the app those personal details that each user chooses to expose to other users on the same social network. Many of the connections on social media are not close relationships. Studies show that some users assert having thousands of followers, while a closer look reveals that the vast majority of those follower are persons which they have never met in person. Frequently, social media users will note a comment and look up the author's Profile. If the Profile is interesting, he or she may decide to establish a “following relationship” (that is “follow the author”) with the author so they can be notified of any future postings or comments by that same author. The system looks for meaningful patterns in the user reactions and automatically generates new content that highlights these patterns, and posts these highlights in that user's Profile. These highlights provide other users with personal details about a user that they can use to decide if they want to establish a following relationship. Importantly, these highlights can also be used by other users that already follow this user and have a close relationship to facilitate more meaningful connections and exchanges around aggregate patterns produced when combining several reactions to individual Storylines over time. Specifically, the meaning that can be extracted when a user reacts to a single Storyline about the Celtics team can be combined with meaning of other reactions to Celtic stories. For example, the system can detect patterns that highlight a user preference for a certain player or team based on his reactions without the user declaring his preference explicitly.

In another example, the system may also keep track of some or all of a user's indications, that is the user's “Takes”, as well as the Takes of the user's friends, and the system alerts the user if any of the user's friends back or challenge that user's Takes. The system may also notify the relevant users of the final outcome so that all can learn how they fared.

In another aspect, the systems and methods described herein provide an online sports media publisher that generates personal content that a user can publish, such as publishing to a data feed on a social media platform. To this end, the system may include an “App” (an application) that acts as a specialized media publisher, much like newspapers, blogs, and television broadcast dedicated to one topic of interest to a large community, such as a professional sports league like the NBA. The App generates or publishes Storylines about “newsworthy events” in that topic. In the sports topic, newsworthy events may be any event that could be of interest to the persons interested in sports, whether as entertainment, business or otherwise. For example, the time of a particular upcoming baseball game may be a newsworthy event, or the names of the starting pitchers set for the game could be a newsworthy event. The system may have algorithms and human curators that examine and analyze recent performance of sports teams, like the Yankees, and players, such as Aaron Judge, and look for “Storylines” that setup an interesting plot point, such as whether a hitting streak of Aaron Judge will continue in the upcoming game in which he is playing. Both the historical events that combined to shape the Storyline that the system uncovered and the upcoming performance that will move the plot along are “newsworthy events”. Also, in certain examples the Storylines are designed to communicate and provide two opinions. The two opinions are (a) whether a specific set/sequence of Team or Player historical events mean something, such as whether there is a streak, a bad or poorly played last game, or breakout performance (these editorial opinions may be based on human-curator judgements or on machine-learning algorithms that find patterns of performance that are out of the ordinary (and can be used to anchor the Storylines), and (b) whether the specific level of performance in the next game for this Team or Player would be a good basis for an argument-worthy premise, based on human curator judgment, or machine-learning algorithms about what that level of performance is. Thus, the application can find hitting streaks and consider whether the streak will continue. Or, the system may find that a specific team has a high rate of stolen third bases against left-handed pitchers, and query whether a player on the team will steal third base in the next scheduled game.

Systems such as those described above generate engaging and valuable content for users which is engaging, personalized, and interesting content. In order to generate content of this type, significant computational resources are expended performing data analytics on large quantities of data to find minute details, trends, and scenarios which the system determines will generate content with the desired qualities. A great deal of processing power is required to perform the personalization, filtration, modification, and other techniques described above to turn large quantities of raw data into valuable game content. Furthermore, servers must be employed to execute these functions which further contribute to the costs of generating this content. There is a need for systems which recognize the value within their most expensive content and design additional low-cost subsystems where that content can provide further value.

To provide an overall understanding of the systems and methods described herein, certain illustrative embodiments will now be described. However, it will be understood by one of ordinary skill in the art that the systems and methods described herein can be adapted and modified for other suitable applications and that such other additions and modifications will not depart from the scope hereof.

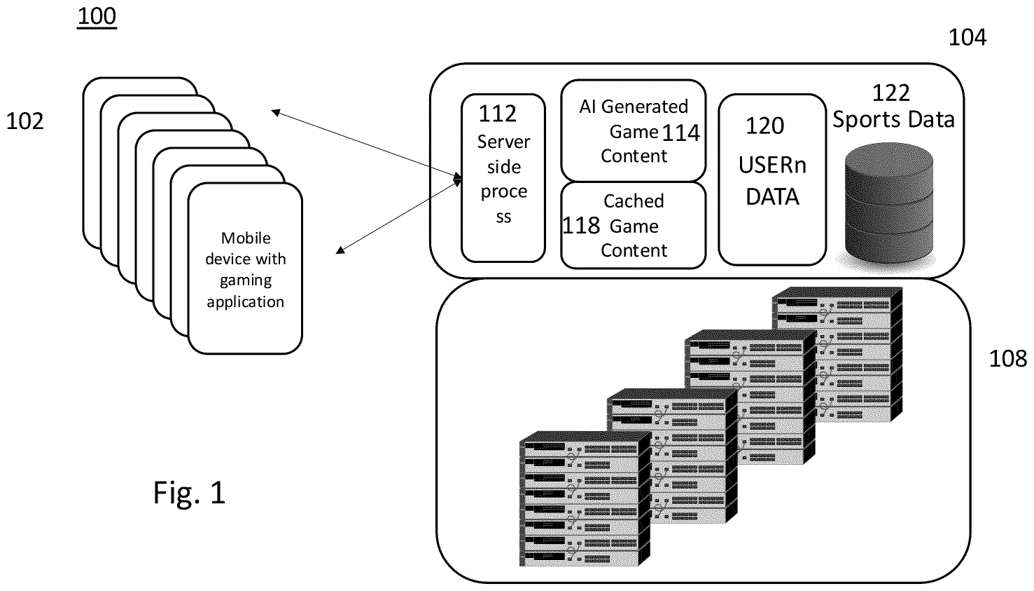

FIG. 1 shows a functional block diagram of one example system 100 which generates content through computationally expensive means. In particular, system 100 includes a server-side application 104 that connects bi-directionally, to an gaming application 102 operating on a mobile device. The gaming application 102 can execute on the user's mobile device, typically a cell phone, and the user can play the game. The FIG. 1 depicts that multiple users can be using the same client side gaming app by showing the cascade of mobile devices running the client side application 102. In practice, as it will be understood by the those of skill in the art, it is commonly the case that thousands of users are running the client side application and making calls to the server side application at the same time or essentially the same time. Moreover, as will be described in this embodiment, the game disclosed herein includes a sports game that is connected to a sporting event taking place in real life. In one particular implementation of the game, the players are to answers several questions predicting certain events that may occur during the game that will be played. One rule of this example game is that questions need to be answered before the game begins play. As such, and as is often the case with many on-line game, there are points of peak demand, such as shortly before a deadline, such as the scheduled start of the game. As such, the system 100 is configured as a system that supports a client-server gaming application where the client is operating on a user's mobile device, and there are multiple users running the client-side application and the server process 112, depicted in FIG. 1 as server-side process 112, executes on the server-side application 104 and exchanges data with the client-side applications. The connection between the client-side application and the server side can be through the typical telecommunication interface commonly used by client-server applications running on a mobile device.

The server-side application 104 operates on the remote servers in a server farm, depicted as the server farm 108 shown pictorially as below and therefore supporting the server side application 104. The server farm 108 can be the AWS system or any set of servers sufficiently powerful to support the multiple users running the client side application 103. The server farm, such as the depicted server farm 108, also known as a server cluster, will typically be a collection of computer servers usually maintained by an organization to supply server functionality well beyond the capability of a single computer. Server farms typically consist of thousands of computers which require a large amount of power and air conditioning to maintain. They are used for the purpose of clustering servers, providing network infrastructure and facilitating the efficient execution of high-volume processes. Typically a server farm includes certain services for providing reliable large scale services, including Redundancy and Reliability: Multiple servers ensure that in the case of hardware failure, the network can continue to function properly; Scalability: Server farms allow for easy expansion. More servers can be added to the farm to increase processing power and storage capacity as needed; High Availability: They are often used for hosting web services, cloud computing resources, and virtual data centers, where uptime is critical; Load Balancing: Server farms often distribute workloads across multiple machines to optimize resource use, maximize throughput, minimize response time, and avoid overload of any single server; Energy Consumption and Cooling Needs: Due to the high concentration of servers, server farms often have significant requirements for electricity and cooling systems to prevent overheating; and Centralized Management: Although the hardware resources are distributed, the management of these resources is typically centralized.

The example server-side application 104 includes several elements that together work to act as a server side program that can implement the features and required actions of the online game being played by the users on their mobile phones period to this end, and in this example, the server side application 104 includes a server side process 112 that is the computer program running on the servers that interacts with the mobile devices and the client side applications 102 and carries out on the server side much of the gaming operation including setting up the game, initiating the game, allowing the users on the client side applications to play the game, determining the outcome of the games and informing the users of that outcome. In this particular example the server side process 112 implements in online sports game that employs and artificial intelligence process to generate content that presents to a game player a question about an upcoming sporting event. For example, the AI process may generate game content such as the depicted game content 114, that considers an upcoming sporting event such as a basketball game in the NBA scheduled for the next day. The AI process may identify and outcome that is likely to occur, such as that a starting player on one of the NBA teams involved in the upcoming game will score a certain number of points. In this embodiment, the AI process determines an outcome that is essentially as likely to occur as it is not to occur. For example, the AI process maybe identify and develop an outcome such as that a certain player, for example Jason Tatum, may score a certain number of points such as 32 points. The AI process may generate game content 114 that formats the identified outcome into a question that can be presented to a gameplayer. For example the AI process may access a database of sports data, such as the sports data base 122, to identify NBA games that are scheduled for the following day. The AI process may analyze sports data associated with the identified game, such as the Celtics versus the Lakers, and consider past performances of certain players such as, Jason Tatum, and identify and outcome that is essentially as likely to occur as not occur, such as that Jason Tatum will score in the upcoming game between the Celtics and the Lakers 32 points. The AI process can develop game content that includes an image of Jason Tatum, some information about the upcoming game such as the teams playing, the time at which the game begins, the records of each team, and other information. Typically, the AI process will include an image such as an image of Jason Tatum prominently within the game content. The AI process can then format the identified outcome, in this example that jason tatum will score 32 points in the upcoming contest, into a question that the user can answer either in the affirmative or negative, such as “Will Jason score 32 points in the upcoming game against the Lakers?”. As part of the game, the generated content may be presented to the user and the user may be allowed to give their Take on the proposed question. The AI process described herein may use machine learning or other data analytics methods typical of AI systems to analyze the sports data and generate the content. These methods produce engaging content by finding interesting insights within the large quantity of data analyzed, but require significant computational resources to perform. Content generated with AI systems of this type is engaging and valuable, but also expensive to produce.

A Take, in some embodiments, may be understood as a user's opinion on a topic, where that topic is typically some newsworthy event. A Take may present the user's opinion, which is the user's reaction or view on a certain proposed issue, sometimes in the form of a question that has two possible answers. The user of the app may express his or her reaction by selecting one of the two possible answers, essentially stating “where he/she stands” with respect to the issue in question, such as the performance of a specific team or player in an upcoming game. Takes, in certain embodiments, are a user's reaction, whether that reaction is logical, emotional or some of each, to the issue presented. In this way, Takes allow a user to express a personal view and convey that view. In this example, Takes are employed by the game to present questions related to sporting events to the players. The players can choose their answer, such as that they believe or they predict that Jason Tatum will score 32 points or alternatively they predict that Jason Tatum will not score 32 points, and can enter their answer through the game content. The game can present one or more of these questions to the game players, typically presenting many questions to each game player, and we'll collect the answers from the game players. In this particular game, once the sporting event has begun, the server side process 104 or the client side process but neither case the game software, initiates a freeze that prevents users from answering anymore questions about the game that has now begun. During the game, such as the NBA game between the Celtics and the Lakers, the gaming software can keep track of the different outcomes that were being measured, such as the number of points being scored by Jason Tatum. At the end of the contest, that is the game between the Celtics and the Lakers, the gaming software can determine the number of points actually awarded to Jason Tatum and can determine whether or not Jason Tatum did or did not score 32 points. At that point the game process can update the content generated about the question, that is whether or not Jason Tatum would score 32 points, to indicate that Jason did or did not score those 32 points. That information can be presented to the user on the client side process 102 shortly after the game has ended, and for some period of time thereafter.

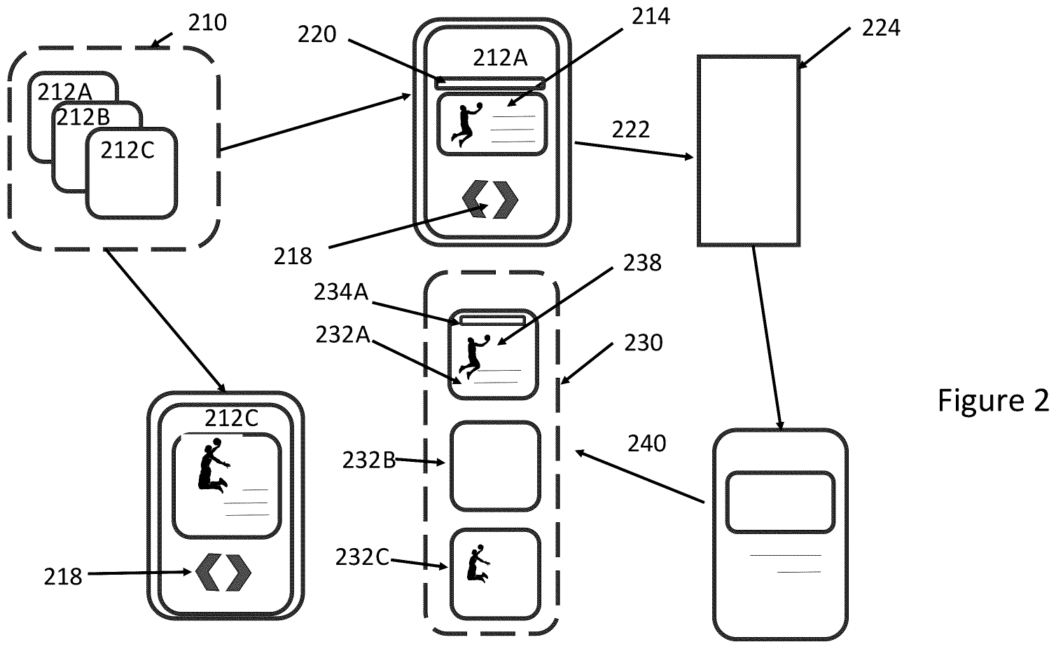

The AI process and other server side processes used for generating the game content can be quite complex and computer processor intensive. FIG. 2 depicts one example of a process for generating game content that can be used by a game such as the game discussed in the example set out above. In this process, the game application 210 processes a data set of sports data, such as the data stored in the database 122 depicted in FIG. 1, to identify patterns within the data set that are associated with a list of predetermined themes having one of two possible outcomes and for generating a headline signal that is representative of a machine displayable string of text and being associated with an identified pattern. The identified patterns are the basis for the published questions 212A-212C. Each published question 212A-212C may have facts, images and other data and content that are relevant to the identified pattern. For example, in a case where a “Great Match-Up” pattern is identified by the machine learning process, the question 212A may include the data underlying the pattern, such as the points-per-game (PPG) for each of two players matched against each other. For example, if the machine learning process identifies for an upcoming game that Mr. Andre Iguodala of the Miami Heat performs well above his historical average of points per game (PPG) when playing against Mr. Markieff Morris of the LA Lakers, who also performs well above his historical average of PPG for this match-up, the question 212A can include all this data as well as images of the players and a countdown until tip-off, as shown by the game question 214 depicted within FIG. 2. The game question can be made available to the game players up to the start of the associated upcoming event, such as an NBA basketball game scheduled for 7:10 pm the following day. The question published to the users presents the point of view by presenting a headline 220. The headline 220 can be a string of text generated by a publisher processor 210. The string of text headline 220 poses a question to the population of users, about the story 214 associated with the headline 220. In this example, a user-selectable switch mechanism 218 is incorporated into the published question 212A, typically by use of template code, by the publisher process 210 and presented to the user so that the user can select between two answers offered.

In one example, the AI process employs machine learning and statistical analysis to determine the questions to ask the user. For example, a machine learning process may select certain parameters, such as the use of three standards of deviation and a sequence of three NBA winning games for a team with a winning record, with a regression analysis that showed that the likelihood of a streak at this level continuing for a fourth game against a team with a losing record is close to 50 percent. With this statistical analysis, the game program can create a game question that has two credible choices, yes or no, both having merit and both allowing the user to select a credible option to post as their personal content on their data feed 230. Machine learning and statistical analysis performed by AI systems produce unique and insightful content due to the ability to analyze large quantities of data to discover patterns, trends, and scenarios which can be hard to find with traditional methods, however complex analysis also requires significant computational resources, such that the output of these systems is content which is both valuable to have, and expensive to produce. There is a need for systems which identify expensive but valuable content of this type and can generate additional avenues to use the content without contributing further to the costs of generating this content.

The monitoring process 224 detects the user input signal 222, typically an indication of either yes or no from the game playing user, and determines that the user has given their point of view as to the question posed, and creates machine displayable content representing the user's point of view and presents it to the user. In this example, the server-side application 12 selects a template 228 that includes a framework of the computer code capable of creating displayable media content. The server-side application 12 can apply the template 228 to generate code that can be published to, in this example, the sports-domain app, or Internet, or other content platform. Optionally, the content generated by the user through this tool can be published to a data feed 230 associated with an account held by the user of the sports-domain app. In this example, the server-side application will apply the template 228 to create content 232A that expresses the user's view point and does so in a way that employs the media capabilities of a computer mark-up language, such as HTML. To this end, the server-side application may create a new headline 234A for the post 232A such as “Mike says “Playoff Rondo” is here for the whole series!”.

By answering the game questions, a user predicts the outcomes of certain game events and has those predictions locked in before the game begins. After the game takes place, the game program can determine for each question answered whether the user was right or wrong in their predictions and award points based on the number of correct answers.

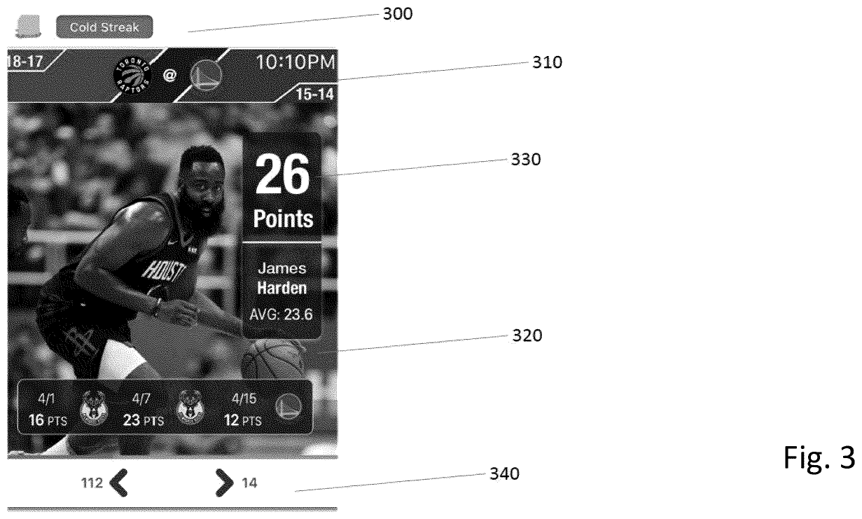

FIG. 3 depicts one example of a game question presented to a user. The game question 300 includes an indication of the AI produced game questions such as whether or not a cold streak will continue, information relevant to the question being posed, such as the teams that are playing and the respective records of those teams as well as the time at which the contest will take place, in this example 10:10 PM. The question is then posed such as will James Harden score 26 points in the upcoming contest when his average is 23.6 and he has been in fact cold during the last few games. The user is provided an input 340 that allows them to either indicate that they predict Mr. harden will score 26 points or he will not score 26 points. Additionally as can be seen at FIGS. 3 and 340 there is numeric values in this case 112 and 14 that indicate the number of people who have indicated that Mister harden will or will not reached 26 points in the upcoming contest.

In any case, it can be seen that the game content generated as presented in FIG. 3 requires substantial computing resources to analyze sports data, use, often through machine learning processes that are intensive processes, questions that are statistically as likely to be answered in the affirmative as in the negative, and image processing capabilities that are capable of taking an image from a sports database such as Sport Radar of the United Kingdom, of a player such as Mr. Harden, cropping that image and doing other image processing so it fits within the content template well, and adding to that additional information such as banners that indicate the question being proposed, in this case whether a cold streak will continue 300, and information about the general facts of the contest such as the players involved, the teams involved the records of those teams and at what time the contest begins. It will be understood by those of skill in the art that thousands of these game questions are generated employing substantial computing power from the server farm to generate those game questions for use in the upcoming contest between game players. Furthermore, it should be noted that this content is created with a single use in mind when the processes are analyzing the data and making determinations, attempts to modify the content itself for use in additional purposes will require additional resources to alter the content. There is a need for systems which recognize the expensive and value content already present in the system, and design additional avenues to create value from the content with low-cost methods.

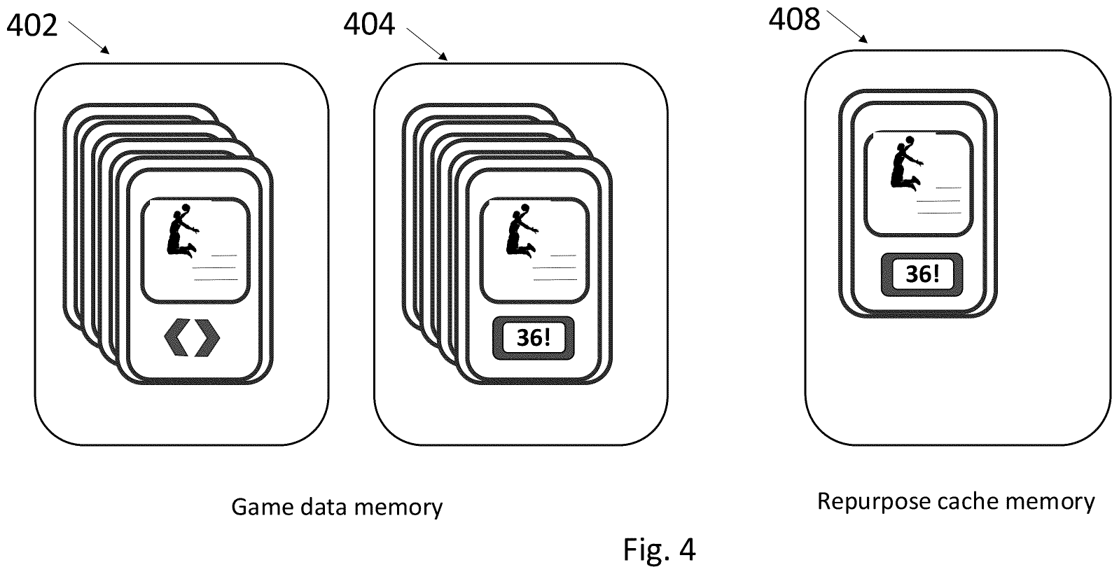

FIG. 4 depicts pictorially a system that stores game generated data in a repurposed cache memory. In particular FIG. 4 depicts generated game data 402 and 404. Generated game data 402 can represent the game data generated prior to the beginning of the contest in the predicted game described above. That is, it proposes different game questions to a user prior to the contest taking place. As further depicted in FIG. 4A memory 404 can store the game questions after completion of the respective contest. For example, 404 represents data which has been updated to indicate the actual outcome which occurred during the sporting event. In the example depicted in FIG. 4 a question had been asked as to whether or not Jason Tatum would score 36 points or more in an upcoming contest against the LA Lakers. As depicted in FIG. 4 game data 402 poses the question to a user as to whether Mr. Tatum will score sufficient points. Users can enter their answer and those answers are collected prior to the beginning of the contest, known as tipoff. The data memory 404 shows the game content updated after the contest. In this case 36 points with an exclamation point is depicted to show that Mister Tatum did actually reach 36 points in the contest between the Boston Celtics and the LA Lakers. In either case the data 402 and 404 is data generated for the first contest, the prediction game, and it is stored in a data memory. In the systems methods described herein that data content is then stored in a repurposed cache memory 408. In the embodiment depicted by FIG. 4 it is the updated content from data memory 404 that is stored in the repurposed cache memory 408. This represents a substantial amount of computing power used to generate the questions, monitor the outcome of the sporting event, update the content, change the images and reformat the data all of which is resource intensive. As such content is treated as an asset to be repurposed for use in a different online game having a different format from the first game for which the content was generated.

The systems and methods described here in repurpose content generated, such as game content questions 300 depicted in FIG. 3, and to that end as depicted in FIG. 1 include a cache that may be employed to store game content information and repurpose it for a subsequent game different from the first game played, in this example a prediction game. In particular, the server application 104 of FIG. 1 includes a cast game content memory 118. The cached game content memory 118 stores game content generated during the production of game content in the first game, the prediction game, and stores that generated content 408 subsequent game. By repurposing generated content, which is the most computationally expensive content to generate, the online gaming system 100 of FIG. 1 greatly reduces the resources needed for supporting online gaming.

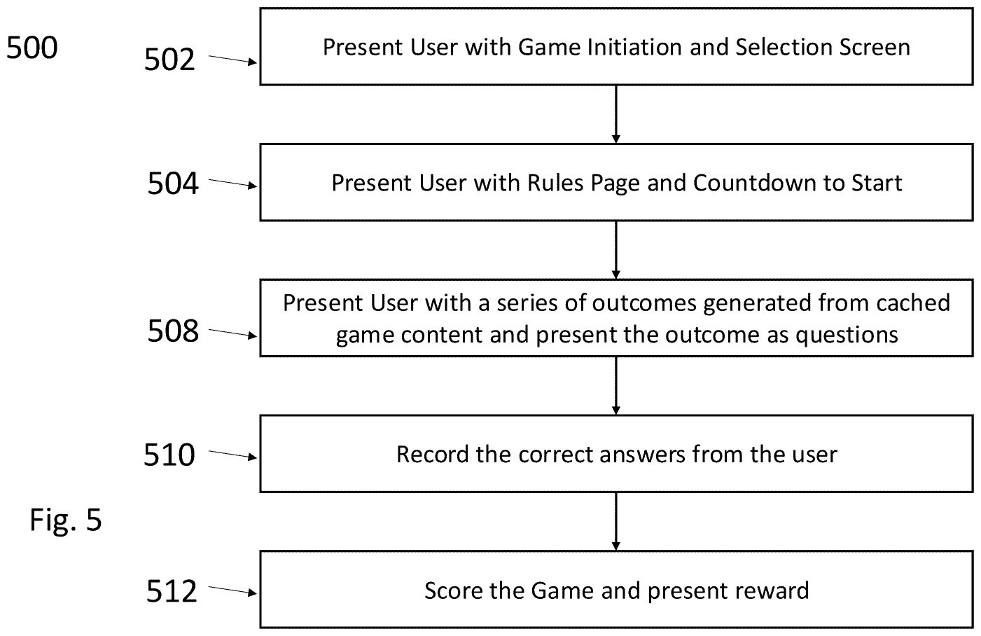

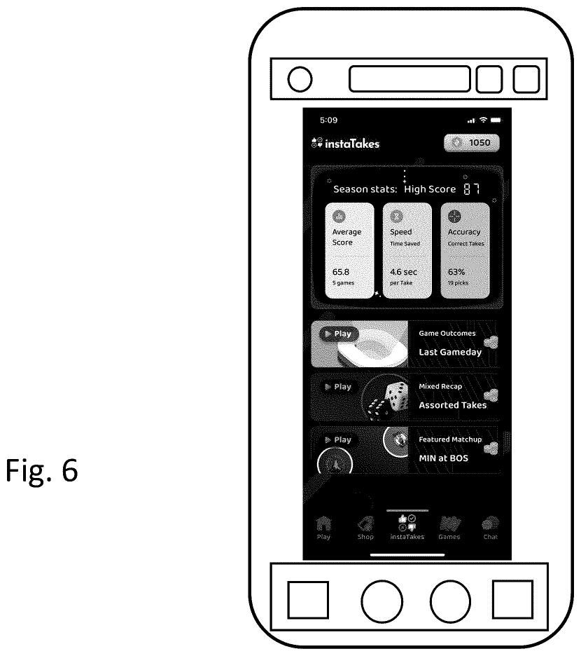

One example of a game that can be generated using repurposed content stored in the cache memory 408 depicted in FIG. 4, is described by the process 500 of FIG. 5. In general the process 500 is for a memory game that uses the previously generated content to present questions to the game player/user. In general, this is a memory game that invites a user to play the game, sets out the rules of the memory game and in this case activates a countdown timer. Within a defined period, the process will present outcomes, which are the actual event that took place and the score or result of that event, presented as part of game content to the player, and asks the player to remember what the outcome actually was. The game then tallies up the number of questions that the player answered correctly and presents a score. The score can be associated optionally with an award such as tokens that can be redeemed for different prizes including for example discounts at restaurants or other organizations that are sponsoring this contest. More particularly, the process 500 starts at 502 which begins with presenting the user with a game initiation and selection screen. This is for a new game one that isn't a predictive game but one that's a memory game period in this particular game a user will be presented with game content questions of the type that were developed for the prediction game period however as the game contest is now complete, the outcome is known. As such the game content questions may be employed and presented to the user with a question asking whether the user remembers what the outcome actually was of a particular contest and a particular outcome. For example, the user can be asked whether Mr. Tatum did hit 36 points in the contest the night before or several nights before between the Boston Celtics and the LA Lakers. Returning to FIG. 5, it's noted that after 502 the process 500 proceeds to step 504 in this the user is presented with a rules page and in this example a countdown to start. There the user can see the rules that are being applied to this memory game and have a countdown that indicates when the game is about to begin as this is a time to game where points scored an awarded depends in part on how quickly the user can answer the questions being presented. After 504 the process 500 proceeds to 508. At 508 the user is presented with a series of outcomes that have been generated from the cached game content. The outcomes are presented to the user as questions. In this case the outcome that actually took place such as whether or not Mr. Tatum made 36 points, is hidden from the user and the user is presented with game content that depicts for example Mr. Tatum, the contest at issue, such as the Boston Celtics versus LA Lakers game that occurred the night before, and allows the user to enter their input which can be whether they remember that Mister Tatum did make 36 points or failed to make 36 points. The process 500 then proceeds to 510 where the answers provided by the user for a series of questions such as seven or eight questions, is recorded. At 512 the game 500 scores the game and presents a reward, optionally, to the Game player. As depicted in FIG. 6, the game can be presented on the users' mobile device so that they can play this memory game using the earlier generated content for a previous different game, on their cell phone with an interface similar to the types of interfaces commonly used for online gaming and trivia contests.

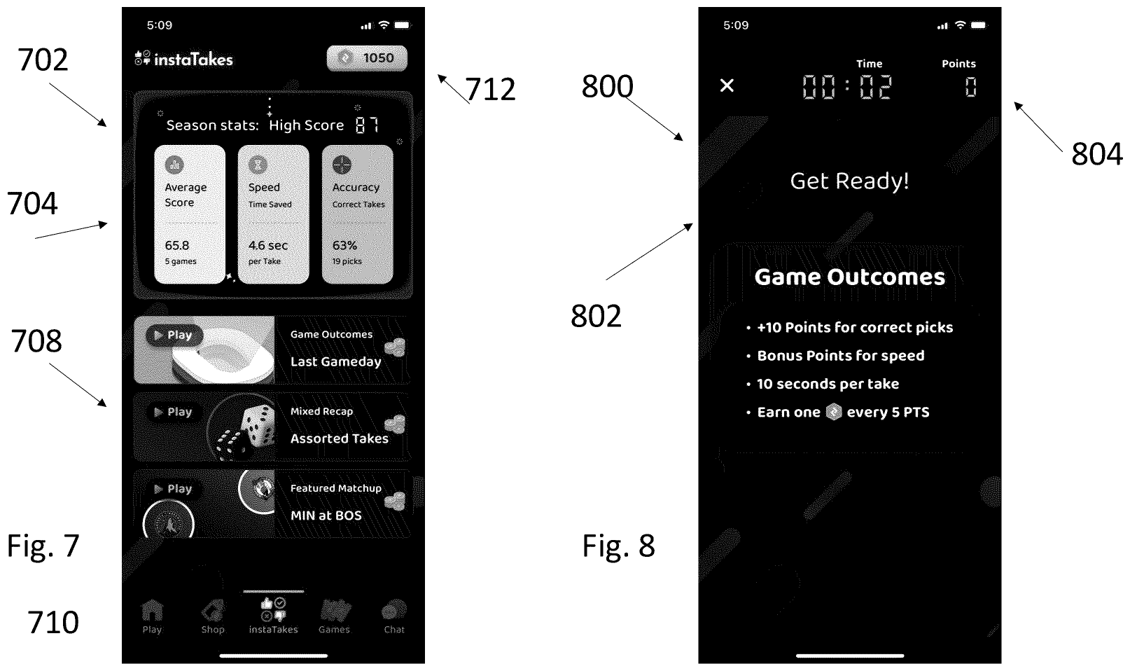

FIG. 7 depicts in more detail the initial screen 700 that shows the games being offered to the user. The Heading Bar 702 includes the title of the game InstaTakes, as well as the Fan Token Wallet 712. The User Stats section 704 includes various stats about the user's past performance on the InstaTakes game, including high score, average score, question answer speed, and their overall accuracy. The Games Selection section 708 includes a set of InstaTakes games for the user to play, with various storylines indicating the type of game questions which will make up the round of InstaTakes, including Game Outcomes, Mixed Recap and Featured Matchup. The navigation bar 710 indicates that the user is in the InstaTakes portion of the app, as well as allowing the user to navigate away from InstaTakes to the other screens depicted.

FIG. 8 depicts the start screen 800 for a round of the InstaTakes game. The Heading Bar 804 includes a timer which counts down to when the game will begin and a points tally indicating the number of points the user has accrued throughout the round, beginning at 0. The rules of the game 802 are depicted in the center along with the title of the storyline of the round of InstaTakes being played and providing the user information about the scoring. When the timer in the Heading Bar 804 reaches 0 the round will begin.

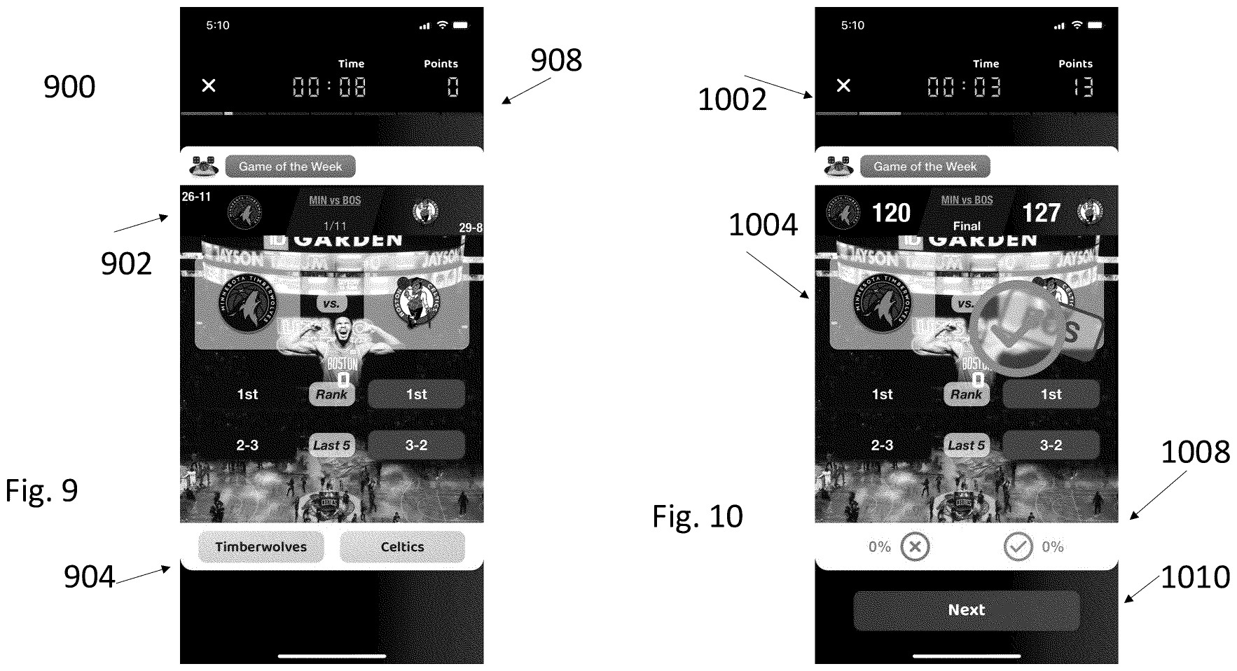

FIG. 9 depicts the process of playing the InstaTakes game with the Game Outcome storyline. The Heading bar 908 includes a timer which counts down for the time the user is allotted to make their choice and a tally of the points they have accrued so far in this round of the game. The Game Tile 902 poses the game question which the user must answer. In this case, what was the outcome of the previous game played by the Minnesota Timberwolves and the Boston Celtics. The content of the Game Tile 902 is the same cached content used to generate the prediction game question about the game outcome, which could have been posed to users through the prediction game. Various information about the teams is shown in the Game Tile 902 such as those team's records, their outcomes in the last five games leading up to the game in question and their ranking within their own division. The user may use this information to make an informed guess about the outcome of the game if they do not remember the actual outcome. The Selection Bar 904 below the Game Tile 902 allows the user to make their choice as to who they believe won the previous contest. The user can make their choice either by tapping on the icons with the name of the team which they believe won, or by swiping the game tile 902 in the directions indicated by the game selection icons.

FIG. 10 depicts a results screen which occurs during a round of the InstaTakes game after the user has made their selection on the game question. The timer in Heading Bar 1002 will stop and the points they may have earned will be added to their tally. The Game Tile 1004 will then show if the user made a correct or incorrect selection on this game question. For example, FIG. 10 depicts a scenario when the user has made the correct selection for the game question. The result of the user's selection is indicated by a green check mark over the team which they selected. The result of the user's choice is further indicated in the Selection Bar 1008. Where the selection they chose has a green check icon. The user may now navigate to the next game question in the InstaTakes round by selecting the next icon 1010.

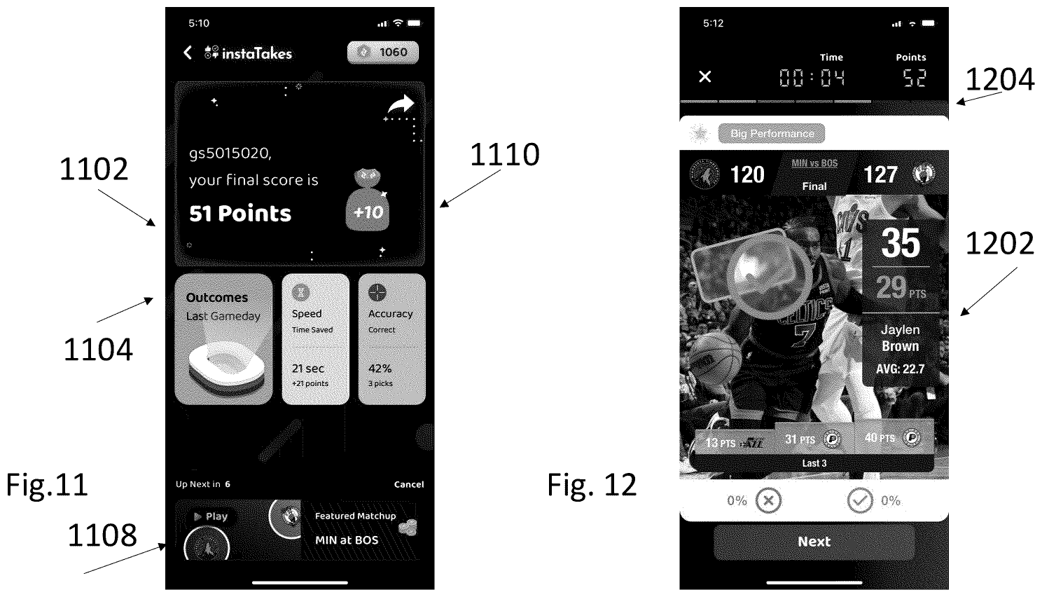

FIG. 11 depicts the final results screen from a round on the InstaTakes game. The Reward panel 1102 indicates to the user their final score of the round and the amount of Fan Tokens they have earned 1110 as a result. The Summary Section 1104 provides information to the user about the round they have just played, such as the storyline of the round, the points they accrued due to speed, and the accuracy of their choices. The Autoplay Section 1108 shows the user that another round of the InstaTakes game is queued to begin, provides the user with a time counting down to when the next round will start and what the storyline of that round will be, as well as giving the user the option to cancel the autoplay function.

FIG. 12 depicts another example of a round of the InstaTakes game with a game question regarding the individual performance of a player. Just as in FIG. 9, the Heading Bar 1204 has a timer which stops when a selection has been made and shows the user the points they have accrued so far in this round of the game. The game tile 1202 had posed to the user the game question of had Jaylen Brown scored 29 points or more in the previous game. The content of the game tile such as the image of Mr. Brown, and statistics about the points he has scored in previous games, are all cached information which was generated as a game question for the prediction game. The game question which could have been posed to users by the prediction game is here presented to users as a trivia question about Mr. Brown's past performance in the completed contest.

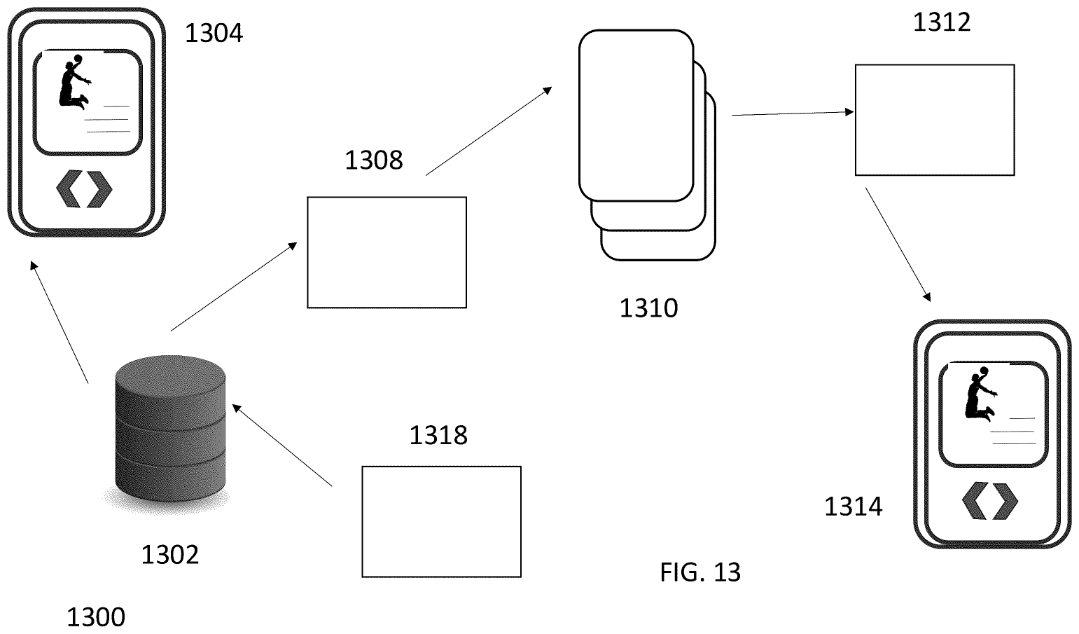

FIG. 13 depicts an embodiment of the system 1300 configured to generate AI content for a predictive game and subsequently repurpose content from the predictive game for use in a trivia game. The system 1300 includes a server 1302, an AI generated question prompt for a predictive game 1304, a repurposing memory cache 1308, a series of trivia game question prompts 1310, an in-app minigame processor 1312, an in-app minigame 1314 and an AI content generator 1318.

The server 1302 stores digital information of various types, including numerical and textual data, AI generated content, and media. The server 1302 may be internal to the system and operated exclusively for the system, or an external server such as the cloud computing systems commonly used in the field. The server 1302 is capable of receiving new data for storage and provides access to the data stored in the server 1302. In addition to storing elements like an AI generated question prompt or media such as an image, the server 1302 is capable of storing metadata about these elements, such that individual parts of the element can be isolated, indexed, searched, or otherwise accessed by the system 1300. For example, the server may store a large number of images which, when rendered for display, depict the NBA player Jayson Tatum. The server 1302 will store, indexed to each of these images, metadata which indicates that the image depicts Jayson Tatum such that the system 1300 is capable of searching, within the server 1302 for images depicting Jayson Tatum without the need to render the images themselves. This exemplary operation may be performed for elements of an AI generated question prompt such as the AI generated storyline.

The AI generated question prompt for a predictive game 1304 is a prompt comparable to the embodiment in FIG. 3, which is a combination of traditional data and AI generated content which an AI system 1318 has aggregated into a digestible piece of content. The AI generated question prompt 1304 has a number of elements, the traditional data elements include media and statistics relevant to the player and/or teams in question providing context for the question prompt. Additionally, the AI generated question prompt 1304 includes AI generated content within it, including an AI generated storyline indicating additional context surrounding the question prompt which an AI process has discovered using techniques such as machine learning or other data analytics methods typical of AI systems. Additionally, the AI generated question prompt 1304 includes an AI generated statistical threshold, which is displayed prominently in the AI generated question prompt 1304 and indicates to a user what the AI generated question prompt 1304 is asking, particularly for the user to predict whether the identified player or team will meet or exceed the AI generated statistical threshold. In a typical embodiment, the AI system 1318 will use machine learning or other data analytics methods typical of AI systems to determine a statistical threshold for the contest and player in question which has a likelihood of being met of approximately 50%. In some embodiments, the AI generated statistical threshold is a comparison of a statistic between two players or teams in the upcoming contest, where the AI system 1318 has determined the likelihood of one player or team surpassing the other in the chosen statistical category to be approximately 50%. The AI generated question prompt 1304 is generated by a combination of AI generated content from the AI system 1318, and traditional data, all of which is stored in the server 1302.

The repurposing memory cache 1308 stores AI generated question prompts after the contest in question has completed. In a typical embodiment, the AI system 1318 will generate a storyline and statistical threshold for a particular player in a particular contest which will be sent to the server 1302 and indexed to the player and contest in question. Using a combination of the AI generated content and traditional data stored on the server 1302, an AI generated question prompt 1304 will be generated for a prediction game with the elements described above and presented to a user of the prediction game. After the contest relevant to the AI generated question prompt 1304 is complete, the AI generated question prompt 1304 will be resolved, particularly the AI generated statistical threshold will either have been met or not. The resolved question prompt is then stored in the repurposing memory cache 1308. This process is then repeated for each AI generated question prompt 1304 which was generated for each contest which occurred that day in a particular sports league. In some embodiments, a resolved AI generated question prompt may be sent to the repurposing memory cache 1308 regardless of if it was ever presented to a user or not. Using this method, the repurposing memory cache 1308 is capable of storing in one location all the relevant content necessary for the in-app trivia minigame 1314 without any of the additional content such as media, statistics, or AI generated content stored in the server 1302 which was not used in any of the AI generated question prompts 1304 made for the prediction game. Additionally, the repurposing memory cache stores metadata regarding the stored question prompts which allows the in-app minigame processor 1312 to easily access a particular question prompt the in-app minigame processor 1312 needs. This allows the in-app minigame 1314 to use the repurposing memory cache 1308 as a dedicated repository for all its necessary information while providing the computational efficiency of accessing only relevant content.

The AI generated question prompts 1304 which are resolved at the end of their relevant contests and stored in the repurposing memory cache 1308 are repurposed into a series of trivia game question prompts 1310. The series of trivia game question prompts 1310 includes a repurposed version of each AI generated question prompt 1304 where the AI generated statistical threshold which had been resolved where the AI generated statistical threshold does not indicate whether the statistical threshold was met or not in the contest. The series of trivia question prompts 1310 includes the elements generated by the AI generator 1318 including the AI generated storyline and the AI generated statistical threshold, as well as the traditional data elements including the media and statistics which were first processed into the prediction game question prompt 1304. Additionally, the series of trivia game questions 1310 include metadata about each question prompt in the series 1310, which the in-app minigame processor 1312 can use to more quickly select particular question prompts in the series 1310 which the in-app minigame processor 1312 chooses.

The in-app minigame processor 1312 operates the functions of the in-app minigame 1314 including selecting, from the series of trivia game question prompts 1310, a set of trivia question prompts for use in a round of the in-app minigame 1314. The in-app minigame processor 1312 may analyze the series of trivia game question prompts 1310 to select a set of questions prompts where the set meets certain criteria. The criteria for selection can include variety of AI generated storylines among selected question prompts, variety of players or teams in selected question prompts, variety of contests in selected question prompts, or other similar criteria used to ensure the set of selected question prompts produces an interesting set of questions for the in-app trivia minigame 1314. In some embodiments, the in-app minigame processor analyzes the series of trivia game question prompts 1310 in order to select a set of question prompts that fit a particular theme. In such an embodiment, for example, the in-app minigame processor 1312 may select 10 question prompts from the series of trivia game question prompts 1310 which all have the same AI generated storyline, such as the “Great Matchup” storyline, to generate a round of the in-app minigame 1314 with the theme of “Great Matchups”. In this exemplary embodiment, the in-app minigame processor 1312 simply searches the series of trivia game question prompts 1310 for 10 instances of question prompts with the “Great Matchup” storyline, which can be identified from the metadata regarding each question prompt. Additionally, the in-app minigame processor may consider other criteria such as ensuring a variety of players, teams, and/or contests within the selected set, for example the in-app minigame processor 1312 may determine that a maximum of 2 selected question prompts may be regarding the same player. In this embodiment, the in-app minigame processor is able to generate a set of trivia questions for the in-app trivia minigame 1314 which leverages the AI generated content generated by the AI system 1318 without requiring the expensive computational resources to perform the machine learning or other data analytics methods again. The effect of this system allows the in-app minigame processor 1312 to operate as if it is analyzing potentially multiple years of sports statistics to identify interesting statistical questions which had an approximately 50/50 chance of occurring or not, and simultaneously identifying interesting statistical events such as when two players tend to produce anomalous statistics while competing against each other, simply by searching numerical and textual metadata in the series of trivia game question prompts 1310. This results in a significant drop in the power requirements to operate an AI enhanced in-app trivia minigame 1314 both from the perspective of the user and the provider of the in-app trivia minigame 1314.

The in-app trivia minigame 1314 can be operated on a mobile computing device, such as a smartphone or tablet, and will present a user with a set of trivia questions including a set of AI generated content, media, and statistics relevant to the question at hand. In a typical embodiment, the in-app minigame processor 1312 selects a set of trivia question prompts from the series of trivia question prompts 1310 based on a predetermine theme. The in-app minigame processor 1312 may select one, two, three, or more sets each having a different theme for any given day. The in-app minigame 1314 presents a user with selectable options for each theme selected by the in-app minigame processor 1312. The user will select a themed set, and the in-app minigame will present the user with the set of trivia questions where the user has a set time limit to answer each question by indicating whether the user believes the player or team in question met or fell below the AI generated statistical threshold in each question. The in-app minigame 1314 tabulates the users' correct and incorrect answers and subsequent to the user completing each question, or the time limit expiring for each question, presents the user with a recap section. The recap section will display to the user statistics regarding the user's performance in the round of the in-app minigame 1314 the user just completed. The user may then be prompted to select a different themed set of trivia questions to complete another round of the in-app minigame 1314. In some embodiments, the recap section will also display statistics regarding the user's average or aggregate performance in all rounds of the in-app minigame 1314 the user has ever played. Additionally, in some embodiments, the recap section will display to a user a comparison of the user's performance in the round of the in-app minigame 1314 to another user's performance in the same round of the in-app minigame 1314. Alternatively, in some embodiments, the user may be prompted to share their performance statistics for the round of the in-app minigame with other users.

The systems and methods described herein produce an in-app trivia minigame where each set of trivia questions follows a theme determined by AI statistical analysis of large volumes of sports data via machine learning or other typical AI data analytics methods, and wherein each question in the set of trivia questions asks whether a particular player or team reached an AI generated statistical threshold where a machine learning algorithm or other AI data analytics method determined prior to the contest that the likelihood of meeting the threshold was approximately 50%. In a typical system in order to generating a game with these questions would require a processor to apply AI methods, like machine learning, to a large set of sports data and expend significant computational resources in order to generate the interesting statistical thresholds and determine the compelling themes. However, with the systems and methods described herein, and in-app trivia minigame 1314 with trivia questions that meet this criteria may be operated with a simple, efficient in-app minigame processor 1312 which simply access textual and numerical metadata from a series of generated trivia question prompts 1310. This is accomplished by leveraging and repurposing AI generated prediction game questions 1304 without the need to integrate the AI system 1318 directly into the in-app trivia minigame 1318.

Those skilled in the art will know or be able to ascertain using no more than routine experimentation, many equivalents to the embodiments and practices described herein.

Accordingly, it will be understood that the invention is not to be limited to the embodiments disclosed herein, but is to be understood from the following claims, which are to be interpreted as broadly as allowed under the law.

1. A system for repurposing artificial intelligence (AI) generated content to operate an AI-enhanced trivia game with reduced power costs, comprising;
a server storing media and statistics from previously played contests in a sports league, and AI generated question prompts for a prediction game, where
the AI generated question prompts include an AI generated statistical threshold where an AI process had determined the likelihood of meeting or falling below the statistical threshold is about 50%,
the AI generated question prompts ask the user to predict if the AI generated statistical threshold will be met by a player in a contest indicated by the question prompt,
a repurposing memory cache which stores the AI generated question prompts after the contest indicated in each question prompt is complete,
a minigame processor configured to access the repurposing memory cache, analyze the stored AI generated question prompts, and select a subset of the stored question prompts to generate a set of trivia question prompts, where
each trivia question prompt corresponds to a stored AI generated question prompt for the prediction game.

2. The system of claim 1 wherein the AI generated question prompts further comprise;
an AI generated storyline element wherein the AI generated storyline represents a statistical trend identified by an AI process.

3. The system of claim 1 wherein the minigame processor analyzing the stored AI generated question prompts comprises;
analyzing the stored AI generated storyline associated with each question prompt, and
analyzing the stored statistics of previously played contests associated with each question prompt, and
analyzing the AI generated statistical threshold associated with each question prompt.

4. The system of claim 2 wherein a trivia question prompt corresponds to a stored AI generated question prompt comprises:
the trivia question prompt uses the stored AI generated statistical threshold from the corresponding prediction game question prompt as the statistical threshold for the trivia question prompt, and
the trivia question prompt uses the stored AI generated storyline from the corresponding prediction game question prompt as the storyline for the trivia question prompt, and
the trivia question prompt uses the stored media from the corresponding prediction game question prompt as the media for the trivia question prompt, and
the trivia question prompt uses the stored statistics from the corresponding prediction game question prompt as statistics for the trivia question prompt.

5. The system of claim 1 where statistics of previously played games include statistics on individual player's past performance and team's past performance.

6. The system of claim 1 where stored media includes images of players during gameplay, images of stadiums during and outside of gameplay, headshots of players, team logos and names of players and teams.

7. The system of claim 1 where the stored AI generated statistical threshold alternatively comprises a comparison between two teams or two individual players performance in a particular statistic where the AI process has identified the probability of one team or player being superior to the other as being close to 50%.

8. The system of claim 1 where the in-app minigame comprises providing the user with the selected set of trivia question prompts presented in the format of yes or no questions as to if a player or team met the stored AI generated statistical threshold during the previously played contest in question, and;
where the user is given a time limit to answer the question and receives more points for correctly answering the question faster.

9. The system of claim 8, wherein providing a user with a set of trivia question prompts and a time limit to answer the questions comprises a round of the in-app minigame.

10. The system of claim 8 wherein subsequent to completing each round of the in-app minigame the user is presented with a recap section displaying the users' performance in the previous round, including the users' accuracy and answer speed.

11. A method of generating an AI enhanced in-app trivia game by repurposing AI generated content, stored media, and statistical information, comprising;
storing in a server media and statistics regarding previously played contests in a sports league, and AI generated question prompts, generated using computationally expensive methods, for a prediction game regarding previously played contests in a sports league,
processing the stored AI generated question prompts to generate a series of question prompts for a trivia game which correspond to the stored AI generated question prompts for the prediction game,
selecting, from the series of question prompts for the trivia game, a set of question prompts for a trivia game,
providing, on a mobile computing device, the set of question prompts for a trivia game as a round of an in-app trivia minigame to a user,
analyzing the users' performance in the round of the in-app trivia minigame and displaying statistics regarding the users' performance to the user subsequent completion of the round of the in-app trivia minigame.

12. The method of claim 11 wherein storing AI generated question prompts for a prediction game comprises;
storing AI generated statistical thresholds where meeting or falling below the statistical threshold determines the result of the AI generated question prompt,
storing AI generated storylines regarding the context of the AI generated question prompt in the sports league,
storing media and statistics for display with the AI generated question prompt providing context regarding the statistical threshold and relevant statistics from the sports league.

13. The method of claim 12 wherein the stored AI generated statistical thresholds alternatively comprise a comparison between two teams or two individual players performance in a particular statistic where an AI process has determined the probability of one team or player performing better in the particular statistic is about 50%.

14. The method of claim 12 wherein generating a series of question prompts for a trivia game which correspond to stored AI generated question prompts for a prediction game comprises;
generating a trivia question including,
a statistical threshold from a previously played contest in a sports league, and
a storyline regarding context of the statistical threshold in the sports league, and
media and statistics regarding context of the statistical threshold in the sports league,
wherein;
the statistical threshold of the trivia question is a stored AI generated statistical threshold from a stored AI generated question prompt for a prediction game, and
the storyline of the trivia question is a stored AI generated storyline from a stored AI generated question prompt for a prediction game, and
the media and statistics for the trivia question are the stored media and statistics from a stored AI generated question prompt for a prediction game.

15. The method of claim 14 wherein selecting a set of question prompts for a trivia game comprises;
analyzing the stored AI generated storylines of the stored AI generated question prompts and selecting a set of stored question prompts which have storylines relevant to each other, and
analyzing the stored statistics regarding the result of previously played contests and the stored AI generated statistical thresholds to select a set of trivia question prompts with a sufficient variety of questions which met and failed to meet the stored AI generated statistical threshold, and
analyzing the stored media and statistics for each question prompt in the series of question prompts to select a set of trivia question prompts with a sufficient variety of different players, teams, and statistics at issue in each question prompt in the set of question prompts.

16. The method of claim 12 wherein displaying statistics regarding a users' performance in the in-app minigame comprises;
displaying a statistic regarding the accuracy of the players choices as a percentage or fraction of the total possible correct choices, and
displaying a statistic regarding how quickly the user answered each question on average, and
displaying a statistic regarding how quickly the user completed the round.

17. The method of claim 16 wherein displaying statistics regarding a users' performance in the in-app minigame further comprises;
displaying, in addition to a users' own statistics, the statistics of another user in a round of the in-app minigame.
